(19) United States
(12) Patent Application Publication
(10) Pub. No.: US 2009/0246414 A1
(43) Pub. Date: Oct. 1, 2009

(54) OPTICAL FILM, POLARIZING PLATE, AND LIQUID CRYSTAL DISPLAY DEVICE

(75) Inventor: Michio Nagai, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Minato-ku (JP)

(21) Appl. No.: 12/412,541

(22) Filed: Mar. 27, 2009

(30) Foreign Application Priority Data
Mar. 31, 2008 (JP) 2008-091624

(51) Int. Cl. C09K 19/00; B32B 27/32

(52) U.S. Cl. 428/1.1; 428/523

(57) ABSTRACT

An optical film comprising a transparent support, and, disposed thereon, an optically anisotropic layer formed of a composition comprising a liquid crystal compound, wherein the transparent support is a film comprising polypropylene-base resin(s), is disclosed.

### CROSS-REFERENCE TO RELATED APPLICATIONS

This application claims benefit of priority under 35 U.S.C. 119 to Japanese Patent Application No. 2008-091624 filed on Mar. 31, 2008, which is expressly incorporated herein by reference in its entirety.

### BACKGROUND OF THE INVENTION

1. Technical Field

The present invention relates to an optical film, and a polarizing plate and a liquid crystal display device using the same.

2. Background Art

As optical films typically used for optical compensation of liquid crystal display devices, there have conventionally been proposed various optical compensation films each having a transparent support composed of a polymer film, and an optically anisotropic layer composed of a liquid crystal composition provided thereon (see Japanese Patent No. 2587398, for example). Triacetyl cellulose (TAC) film is mainly used as the transparent support.

There have been steady needs for downsizing and thinning of the liquid crystal display devices to be applied to mobile phones and notebook-type personal computers. Downsized and thinned liquid crystal display devices may excessively be elevated in the internal temperature, due to heat of the back-light. These liquid crystal display devices intended for these applications may be used not only in indoor environments but also in outdoor environments, under various conditions. In addition, in-car liquid crystal display devices may excessively be exposed to high-temperature environments. The liquid crystal display devices intended for these applications may, therefore, be required to be less fluctuating in display characteristics against changes in environmental humidity and temperature.

On the other hand, there have been various proposals on combination of a retardation film composed of any film with a polarizing plate (Japanese Laid-Open Patent Publication (JPA) No. 2007-316603). However, no proposal have been made yet on satisfactory level of optical films, such as showing optical compensation performances equivalent to, or superior to those of the conventional optical compensation films having optically anisotropic layers composed of liquid crystal compositions, and successfully reduced in fluctuation in the optical compensation performances against changes in temperature and humidity.

### SUMMARY OF THE INVENTION

It is therefore an object of the present invention to provide an optical film and a polarizing plate, showing optical compensation performances equivalent to, or superior to those of the conventional optical compensation films having optically anisotropic layers composed of liquid crystal compositions, and successfully reduced in fluctuation in the optical compensation performances against changes in temperature and humidity.

It is another object of the present invention to provide a liquid crystal display device excellent in the display characteristics and viewing angle characteristics, and successfully reduced in fluctuation in the display characteristics against changes in temperature and humidity.

The means for achieving the objects are as follows.
[1] An optical film comprising:
   a transparent support, and, disposed thereon,
   an optically anisotropic layer formed of a composition comprising a liquid crystal compound,
   wherein the transparent support is a film comprising polypropylene-base resin(s).
[2] The optical film according to [1], wherein the transparent support is subjected to an adhesion-facilitating treatment.
[3] The optical film according to [1] or [2], further comprising an adhesive layer and/or an alignment film, between the transparent support and the optically anisotropic layer.
[4] The optical film according to any one of [1] to [3], wherein the optically anisotropic layer is a layer formed of a liquid crystal composition comprising at least a single species of discotic liquid crystal compound.
[5] A polarizing plate comprising at least an optical film according to any one of [1] to [4], and a polarizing film.
[6] A liquid crystal display device comprising at least a liquid crystal cell, and a polarizing plate according to [5].
[7] A liquid crystal display device according to [6], wherein the liquid crystal cell employs a TN mode, OCB mode or IPS mode.

### DETAILED DESCRIPTION OF THE INVENTION

The present invention will be detailed below. Note that any numerical expression in a form of “ . . . to . . . ” in this specification will be used to represent a range including the numerals given before “to” and after “to” as the lower and upper limits, respectively.

### [Optical Film]

The present invention relates to an optical film having a transparent support, and, disposed thereon, an optically anisotropic layer formed of a composition containing a liquid crystal compound. According to the invention, the transparent support is a film containing polypropylene-base resin(s). By using a film containing polypropylene-base resin(s) as the transparent support, the present invention successfully provides an optical film showing optical compensation performances equivalent to, or superior to those of the conventional similarly-configured optical compensation films having optically anisotropic layers composed of liquid crystal compositions, and successfully reduced in fluctuation in the optical compensation performances against changes in variations in temperature and humidity. As a consequence, the liquid crystal display devices having the optical film of the present invention as the optical compensation film (or a protective film for the polarizing plate) are characterized by their desirable display characteristics and viewing angle characteristics, and also by their small fluctuation in the display characteristics against changes in temperature and humidity.

The individual components of the optical film of the present invention will be explained below.

### (Transparent Support)

According to the invention, the transparent support of the optical film is a film containing polypropylene-base resin(s). The film preferably contains a single species, or two or more species of polypropylene-base resin. The film may contain one or more additives described later. By using the film containing the polypropylene-base resin(s), fluctuation in the optical compensation performances against changes in temperature and humidity may be reduced, and the frontal contrast (contrast in the direction normal to the display screen) may be improved.

The polypropylene-base resin may be selected from homopolymers of propylene. The resin is selectable also from copolymers of propylene copolymerized with one or more monomers co-polymerizable therewith, where it is preferable that propylene is the major monomer, and that the co-monomer(s) copolymerized therewith is less in the amount than polypropylene, typically copolymerized to as much as 20% by mass or less, and more preferably 10% by mass or less. Although the lower limit value is not specifically limited (of course, the content of the co-monomer can be 0% by mass), the co-monomer may be copolymerized to as much as 1% by mass or more, so as to contribute to the characteristics of the polymer.

Examples of the co-monomer to be copolymerized with propylene include ethylene and C₄₋₂₀ α-olefins. Examples of such C₄₋₂₀ α-olefin include:

C₄ α-olefins such as 1-butene and 2-methyl-1-propene;

C₅ α-olefins such as 1-pentene, 2-methyl-1-butene and 3-methyl-1-butene;

C₆ α-olefins such as 1-hexene, 2-ethyl-1-butene, 2,3-dimethyl-1-butene, 2-methyl-1-penetene, 3-methyl-1-pentene, 4-methyl-1-penetene and 3,3-dimethyl-1-butene;

C₇ α-olefins such as 1-penetene, 2-methyl-1-hexene, 2,3-dimethyl-1-pentene, 2-ethyl- 1-penetene and 2-methyl-3-ethyl-1-butene;

C₈ α-olefins such as 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene and 2,3-diethyl-1-butene;

C₉ α-olefins such as 1-nonene;

C₁₀ α-olefins such as 1-decene;

C₁₁ α-olefins such as 1-undecene;

C₁₂ α-olefins such as 1-dodecene;

C₁₃ α-olefins such as 1-tridecene;

C₁₄ α-olefins such as 1-tetradecene;

C₁₅ α-olefins such as 1-pentadecene;

C₁₆ α-olefins such as 1-hexadecene;

C₁₇ α-olefins such as 1-heptadecene;

C₁₈ α-olefins such as 1-octadecene; and

C₁₉ α-olefins such as 1-nonadecene.

Among α-olefins, preferred are C₄₋₁₂ α-olefins such as 1-butene, 2-methyl-1-propene, 1-penetene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2-methyl-3-ethyl-1-butene, 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene, 2,3-diethyl-1-butene, 1-nonene, 1-decene, 1-undecene, and 1-dodecene. In terms of copolymerization-ability, 1-butene, 1-pentene, 1-hexene and 1-octene are preferable; and especially, 1-butene and 1-hexene are more preferable.

The copolymer may be a random copolymer or block copolymer. Preferable examples of the copolymer include propylene/ethylene copolymers and propylene/1-butene copolymers. In propylene/ethylene copolymers and propylene/1-butene copolymer, the contents of ethylene unit and 1-butene unit may be determined by a method based on infrared (IR) spectrometry, described in “Kobunshi Bunseki Handobukku (Handbook of Polymer Analyses)”, p. 616, (published by Kinokuniya Company, Ltd. in 1995).

In terms of improving the transparency and workability of the film to be used as a transparent support, it is preferable to use a random copolymer containing propylene as a major monomer, randomly copolymerized with arbitrary unsaturated hydrocarbon(s). Among them, copolymers with ethylene are preferable. It may be advantageous to adjust the ratio of copolymerization of the unsaturated hydrocarbon(s) other than propylene to approximately 1 to 10% by mass, and more preferably 3 to 7% by mass. By adjusting the content of unit(s) of the unsaturated hydrocarbon(s) other than propylene to the above described ranges, the film may preferably be improved in the workability and transparency, without extremely degrading the heat resistance due to lowering in the melting point of resin. For the copolymers with two or more species of co-monomer, it may be preferable that the total content of the units derived from all co-monomers contained in the copolymers falls in the above-described ranges.

The polypropylene-base resin to be used in the present invention preferably has a melt flow rate (MFR), of 0.1 to 200 g/10 min, which is measured according to JIS K7210 at 230° C. under a load of 21.18 N, and more preferably 0.5 to 50 g/10 min. By using the polypropylene-base resin having the MFR adjusted to these ranges, uniform film-like products may be obtained without applying a large force to an extruder.

The polypropylene-base resin may be produced according to a method of proceeding homopolymerization of propylene using a known polymerization catalyst, or a method of proceeding copolymerization of propylene with other polymerizable co-monomer(s). Examples of the catalyst include Ti—Mg-base catalysts composed of a solid catalyst containing magnesium, titanium and halogen as essential components; catalytic systems composed of the combination of a solid catalyst containing magnesium, titanium and halogen as essential components, organo-aluminum compound(s), and optional third component(s) such as electron donor compound(s); and metallocene-base catalysts.

Among these catalysts, those composed of the combination of a solid catalyst containing magnesium, titanium and halogen as essential components, organo-aluminum compound(s), and electron donor compound(s) are preferable. Examples of the organo-aluminum compound include triethyl aluminum, triisobutyl aluminum, mixture of triethyl aluminum and diethyl aluminum chloride, and tetraethyl dialumoxane; and examples of the electron donor compound include cyclohexylethyl dimethoxysilane, tert-butylpropyl dimethoxysilane, tert-butylethyl dimethoxysilane, and dicyclopentyl dimethoxysilane.

Examples of the solid catalyst containing magnesium, titanium and halogen as essential components include the catalytic systems described in Japanese Laid-Open Patent Publication Nos. syo 61-218606, syo 61-287904 and hei 7-216017; and examples of the metallocene-base catalyst include the catalytic systems described in Japanese Patent Nos. 2587251, 2627669 and 2668732.

The polypropylene-base resin may be produced according to various methods, which are exemplified by solution polymerization using an inert solvent represented by hydrocarbon compounds such as hexane, heptane, octane, decane, cyclohexane, methyl cyclohexane, benzene, toluene, xylene and so forth; bulk polymerization using liquid-form monomer(s) as a solvent; and gas-phase polymerization allowing gaseous monomers to directly polymerize. The polymerization according to these methods may be carried out in a batch process or a continuous process.

The streo-regularity of the polypropylene-base resin may be any of isotactic, syndiotactic and atactic. In the present invention, syndiotactic or isotactic polypropylene-base resin may preferably be used, in terms of heat resistance.

In the present invention, a film containing the polypropylene-base resin as a major constituent may preferably be used as the transparent support, wherein one or more species selected from various additives may be added so far as the effects of the present invention will not be inhibited. Examples of the additives include antioxidant, ultraviolet absorber, antistatic agent, lubricant, nucleating agent, anti-clouding agent, and anti-blocking agent. The antioxidant may be exemplified by phenol-base antioxidant, phosphorus-containing antioxidant, sulfur-containing antioxidant, and hindered amine-base photo stabilizer, and may further be exemplified by composite-type antioxidant such as having, for example, a unit provided with both of a phenol-base, anti-oxidative mechanism and a phosphorus-containing, anti-oxidative mechanism in a single molecule. The ultraviolet absorber may be exemplified by ultraviolet absorbers of 2-hydroxybenzophenone-base and hydroxyphenyl benzotriazole-base, and ultraviolet shielding agent of benzoate-base. The antistatic agent may be any of the polymer type, oligomer type and monomer type. The lubricant may be exemplified by higher aliphatic acid amides such as erucic acid amide and oleic acid amide; higher aliphatic acids such as stearic acid, and their salts. The nucleating agent may be exemplified by solbitol-base nucleating agent, organo-phosphate-base nucleating agent, and polymer-base nucleating agent such as polyvinyl cycloalkane. As the anti-blocking agent, spherical or nearly spherical particles may be used irrespective of their inorganic or organic natures. A plurality of these additives may be used in combination.

The polypropylene-base resin may be formed into film by an arbitrary method (a film product subjected to a film-forming process will be referred to as “raw film”, hereinafter). Generally, a raw film may be transparent, and have substantially no retardation in plane. A raw film of polypropylene-base resin, having substantially no retardation in plane, may be obtained typically according to an extrusion molding method employing a molten resin, or according to a solvent cast method employing a resin solution, prepared by dissolving resin in an organic solvent, and comprising casting the solution on a flat surface and then drying it to remove the solvent therefrom.

One example of the extrusion molding method for preparing the raw film is as follows. A polypropylene-base resin is kneaded under fusion with the aid of rotation of a screw in an extruder, and extruded from a T-die to form a sheet. The temperature of the extruded molten sheet is 180 to 300° C. or around. The temperature of the molten sheet at this stage lower than 180° C. may result in insufficient spreadability, so that the obtainable film may be non-uniform in the thickness and may have variation in retardation. On the other hand, the temperature exceeding 300° C. may result in decomposition or degradation of the resin, so that the sheet may have bubbles produced therein, or may contain carbides. The extruder may be a mono-axial extruder or may be a biaxial extruder. As the mono-axial extruder, it may be preferable to use those having an L/D value, which is a ratio of screw length L and diameter D, of 24 to 36 or around, and having a compression ratio, which is a ratio of the spatial volume of thread groove in a resin feeder unit and the spatial volume of thread groove in a resin weighing unit (former/latter), of 1.5 to 4 or around, and having a screw of the full-flight-type, barrier-type, or a type having a Maddock-type kneader element. From the viewpoint of suppressing degradation or decomposition of the polypropylene-base resin, and thereby ensuring uniform kneading under fusion, a barrier-type screw having an L/D value of 28 to 36 and a compression ratio of 2.5 to 3.5 may preferably be used. In addition, in order to suppress the degradation or decomposition of the polypropylene-base resin as possible, an atmosphere in the extruder may preferably be conditioned as a nitrogen atmosphere or vacuum. In order to eliminate volatile gas produced in the process of degradation or decomposition of the polypropylene-base resin, it may be still also preferable to provide an orifice of 1 mm or larger and 5 mm or smaller in diameter at the end of the extruder, to thereby increase the resin pressure at the end portion of the extruder. Increase in the resin pressure at the end portion of the extruder provided with the orifice means increase in the back pressure at the end portion, and thereby stability in the extrusion may be improved. The diameter of the orifice adopted herein is preferably 2 mm or larger and 4 mm or smaller.

The T-die to be used for the extrusion may preferably have no tiny irregularity in height or flaw on the surface of passageway of the resin, the lip portion thereof may preferably be plated or coated with a material having a small friction coefficient with respect to the molten polypropylene-base resin, and the lip end may preferably have a sharp edge shape ground to as small as 0.3 mm or smaller in diameter. The material having small friction coefficient may be exemplified by specialized plated film made of tungsten carbide-base material or fluorine-containing material. By using such T-die, not only die build-up but also die line may be suppressed at the same time, so that the resin film may be obtained with an excellent uniformity in the appearance. The T-die preferably has a coat-hanger-like manifold, and preferably satisfies the condition (1) or (2) below, and more preferably satisfies the condition (3) or (4) below:
If the lip width of T-die is smaller than 1500 mm:

length in thickness direction of T-die>180 mm (1)
If the lip width of T-die is 1500 mm or larger:

length in thickness direction of T-die>220 mm (2)
If the lip width of T-die is smaller than 1500 mm:

length in height direction of T-die>250 mm (3)
If the lip width of T-die is 1500 mm or larger:

length in height direction of T-die>280 mm (4)

By using the T-die satisfying these conditions, flow of the molten polypropylene-base resin in the T-die may properly be controlled, and the resin may be extruded at the lip portion while being suppressed in variation in the thickness, so that the resultant raw film may be more excellent in the accuracy of thickness, and may be more uniform in retardation.

From the viewpoint of suppressing fluctuation in extrusion of the polypropylene-base resin, a gear pump may preferably be attached between the extruder and the T-die. In addition, a leaf disc filter may preferably be attached, in order to remove foreign matters which reside in the polypropylene-base resin.

The molten sheet extruded from the T-die may be nipped between a metal-made cooling roll (also referred to as a chiller roll or casting roll), and a touch roll containing an elastic component which rotates while being brought into contact under pressure with the circumference of the metal-made cooling roll, and cooled and solidified to give a desired film. The touch roll to be used herein may be such as being composed of an elastic member, such as rubber, which directly configures the surface thereof, or may be such as having an elastic member roll covered with an outer cylinder composed of a metal sleeve. For the case where the elastic member roll covered with the outer cylinder composed of a metal sleeve is used as a touch roll, the molten sheet of polypropylene-base resin is generally cooled while being directly nipped between the metal-made cooling roll and the touch roll. On the other hand, for the case where the roll having the surface thereof composed of an elastic member is used as a touch roll, the molten sheet of polypropylene-base resin may be nipped while placing a bidirectionally stretched film of a thermoplastic resin between the molten film and the touch roll.

When the molten sheet of polypropylene-base resin is cooled and solidified while being nipped between the above-described cooling roll and the touch roll, the cooling roll and the touch roll are necessarily be lowered in the surface temperature, so as to rapidly cool the molten sheet. More specifically, the surface temperatures of both rolls may be adjusted to the range from 0° C. to 30° C. If the surface temperatures of those exceed 30° C., the molten sheet may need a longer time for cooling and solidification, so that crystallizable component in the polypropylene-base resin may grow, to thereby degrade the transparency of the obtained film. The surface temperatures of the rolls are preferably adjusted to lower than 30° C., and more preferably lower than 25° C. On the other hand, if the surface temperatures of the rolls are lower than 0° C., the metal-made cooling roll may catch dew to produce water drops on the surface thereof, which tends to degrade the appearance of the film.

Since the surface condition of the metal-made cooling roll adopted herein is transferred onto the surface of the polypropylene-base resin film, so that any irregularities on the surface may degrade the accuracy of thickness of the obtained polypropylene-base resin film. Therefore, the surface of the metal-made cooling roll is preferably specular as possible. More specifically, the surface roughness of the metal-made cooling roll is preferably 0.3 S or smaller, and more preferably 0.1 S to 0.2 S, when expressed by a preferred number of maximum height.

The touch roll, which forms the portion of nipping together with the metal-made cooling roll, preferably has a surface hardness of the elastic component of 65 to 80, and more preferably 70 to 80, which is measured according to a spring-type hardness test (type A) specified by JIS K6301. By using the rubber roll having this level of surface hardness, the line pressure applied to the molten sheet may more readily be kept constant, and thereby the film-making may be facilitated without producing a bank (resin deposit) of the molten sheet between the metal-made cooling roll and the touch roll.

The pressure (line pressure) applied when the molten sheet is nipped is determined by the pressure of the touch roll pressed onto the metal-made cooling roll. The line pressure is preferably adjusted to the range from 50 N/cm to 300 N/cm, and more preferably to the range from 100 N/cm to 250 N/cm. By adjusting the line pressure to the above-described ranges, the polypropylene-base resin film may more readily be produced while keeping a constant line pressure without forming the bank.

As described above, a biaxially-stretched film of thermoplastic resin may be pinched together with the molten sheet of polypropylene-base resin between the metal-made cooling roll and the touch roll. The thermoplastic resin, which is a material of the biaxially-stretched film, may be selected from those which don't tightly fuse with the polypropylene-base resin, and examples such a thermoplastic resin include polyester, polyamide, polyvinyl chloride, polyvinyl alcohol, ethylene-vinyl alcohol copolymer and polyacrylonitrile. Among these, polyester, less causative of dimensional changes depending on humidity and temperature, is most preferable. The thickness of the biaxially-stretched film to be used is generally 5 to 50 μm or around, and preferably 10 to 30 μm or around.

In this method, the distance (air gap) between the lip of the T-die and the position where the film is nipped between the metal-made cooling roll and the touch roll is preferably equal to or less than 200 mm, and more preferably equal to or less than 160 mm. The molten sheet extruded from the T-die may be stretched while being fed from the lip to the rolls, which may more readily align the molecules in the sheet. By setting the air gap to a small value as described in the above, a raw film having a smaller degree of alignment may be obtained. The lower limit value of the air gap is determined by the diameters of the metal-made cooling roll and the touch roll adopted herein, and by the geometry of the end of the lip adopted herein, and is generally set to 50 mm or larger.

The process speed in the manufacture of the polypropylene-base resin film according to this method is determined by the time necessary for cooling and solidifying the molten sheet. As the diameter of the metal-made cooling roll adopted herein increases, the length of contact between the molten sheet and the cooling roll increases, and thereby the manufacturing may be proceeded at higher speeds. More specifically, if a metal-made cooling roll of 600 mm in diameter is used, the process speed may be raised to as high as 5 to 20 m/min at maximum.

The molten sheet nipped between the metal-made cooling roll and the touch roll is cooled and solidified upon contact with the roll. The sheet is slit at the edges if necessary, and then winded up by a winder to give a wind-up film. In this process, for the purpose of protecting the surface of the film until it is practically used, the film may be winded up together with surface protective film(s) which is composed of another thermoplastic resin, bonded to one surface or both surfaces thereof. For the case where the molten sheet of polypropylene-base resin is nipped together with the biaxially-stretched film of thermoplastic resin between the metal-made cooling roll and the touch roll, the biaxially-stretched film may be used as one surface protective film.

The raw film produced according to the above-described method may directly be used as the transparent support, or may be used as the transparent support after any one process, or two or more processes described below.

### <<Stretching>>

The raw film may be stretched for developing retardation. A film subjected to biaxial stretching process, which shows biaxial birefringence, may be used as the transparent support. The stretching ratios in the machine direction (MD) and the transverse direction (TD) may be decided depending on retardation to be desired. The stretching ratio in one of the two directions that the optical axis is found (that is, the direction, in which stretching with a larger stretching ratio is performed, becomes a direction along the slow axis) may fall within the range from 1.1 to 10; and the stretching ratio in another direction, which is orthogonal thereto (that is, the direction, in which stretching with a smaller stretching ratio is performed, becomes a direction along the fast axis) may fall within the range from 1.1 to 7. Any stretching treatment causing the optical axis along the transverse direction or the machine direction may be used.

As the transparent support of the optical film to be used for optical compensation of TN-mode liquid crystal display devices, a film having retardation in plane at 550 nm, Re(550), of 0 to 100 nm, and retardation along thickness direction at the same wavelength, Rth(550), of 30 to 120 nm may preferably be used.

As the transparent support of the optical film to be used for optical compensation of OCB-mode liquid crystal display devices, a film having retardation in plane at 550 nm, Re(550), of 30 to 60 nm, and retardation along thickness direction at the same wavelength, Rth(550), of 150 to 400 nm may preferably be used.

As the transparent support of the optical film to be used for optical compensation of VA-mode liquid crystal display devices, a film having retardation in plane at 550 nm, Re(550), of 30 to 60 nm, and retardation along thickness direction at the same wavelength, Rth(550), of 30 to 250 nm may preferably be used.

As the transparent support of the optical film to be used for optical compensation of IPS-mode liquid crystal display devices, a film having retardation in plane at 550 nm, Re(550), of 30 to 70 nm, and retardation along thickness direction at the same wavelength, Rth(550), of 70 to 200 nm may preferably be used.

In the description, Re(λ) (unit: nm) and Rth(λ) (unit: nm) each indicate retardation in plane and retardation along thickness direction of a sample, a film or the like, at a wavelength λ. Re(λ) is measured by applying a light having a wavelength of λ nm in the normal direction of the film, using KOBRA-21ADH or WR (by Oji Scientific Instruments). The selectivity of the measurement wavelength λ nm may be conducted by a manual exchange of a wavelength-filter, a program conversion of a measurement wavelength value or the like.

When a film to be tested is represented by an uniaxial or biaxial refractive index ellipsoid, then its Rth(λ) is calculate according to the method mentioned below.

With the in-plane slow axis (determined by KOBRA 21ADH or WR) taken as the inclination axis (rotation axis) of the film (in case where the film has no slow axis, the rotation axis of the film may be in any in-plane direction of the film), Re(λ) of the film is measured at 6 points in all thereof, up to +50° relative to the normal direction of the film at intervals of 100, by applying a light having a wavelength of λ nm from the inclined direction of the film.

With the in-plane slow axis from the normal direction taken as the rotation axis thereof, when the film has a zero retardation value at a certain inclination angle, then the symbol of the retardation value of the film at an inclination angle larger than that inclination angle is changed to a negative one, and then applied to KOBRA 21ADH or WR for computation.

With the slow axis taken as the inclination axis (rotation axis) (in case where the film has no slow axis, the rotation axis of the film may be in any in-plane direction of the film), the retardation values of the film are measured in any inclined two directions; and based on the data and the mean refractive index and the inputted film thickness, Rth may be calculated according to the following formulae (10) and (11):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( 10 ) \\ Rth = \{ ( nx + ny ) \text{/} 2 - nz \} \times d & ( 11 )\end{matrix}$$

wherein Re(θ) means the retardation value of the film in the direction inclined by an angle θ from the normal direction; nx means the in-plane refractive index of the film in the slow axis direction; ny means the in-plane refractive index of the film in the direction vertical to nx; nz means the refractive index of the film vertical to nx and ny; and d is a thickness of the film.

When the film to be tested can not be represented by a monoaxial or biaxial index ellipsoid, or that is, when the film does not have an optical axis, then its Rth(λ) may be calculated according to the method mentioned below.

With the in-plane slow axis (determined by KOBRA 21ADH or WR) taken as the inclination axis (rotation axis) of the film, Re(λ) of the film is measured at 11 points in all thereof, from −50° to +50° relative to the normal direction of the film at intervals of 10°, by applying a light having a wavelength of λ nm from the inclined direction of the film. Based on the thus-determined retardation data of Re(λ), the mean refractive index and the inputted film thickness, Rth(λ) of the film is calculated with KOBRA21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59).

The mean refractive index and the film thickness are inputted in KOBRA 21ADH or WR, nx, ny and nz are calculated therewith. From the thus-calculated data of nx, ny and nz, Nz=(nx−nz)/(nx−ny) is further calculated.

It is to be noted that, in the description, Re and Rth without any notation of the measurement-wavelength mean the values measured at 550 nm.

### <<Adhesion-Facilitating Treatment>>

The surface of the above-described film to be used as the transparent support is preferably subjected to an adhesion-facilitating treatment, in order to improve adhesiveness with an optically anisotropic layer formed thereon, or with an alignment film optionally formed thereon. By this treatment, the transparent support and the optically anisotropic layer may be less likely to separate from each other, even if exposed to high temperature and high humidity, and is thereby improved in the heat resistance. The adhesion-facilitating treatment is preferably corona discharge treatment or atmospheric-pressure plasma treatment. Although, generally, a corona discharge treatment may be classified into an atmospheric-pressure plasma in a broad sense, it is defined in this description as follows. A treatment, which is carried out by directly exposing a sample to a plasma region generated by corona discharge, is referred to as corona discharge treatment, and a treatment, which is carried out by placing a sample apart from a plasma region, is referred to as atmospheric-pressure plasma treatment. The corona treatment is advantageous in that it is well proven in the industrial applications at low cost, but is disadvantageous in that the surface of the sample may physically be damaged to a larger degree. On the other hand, the atmospheric-pressure plasma treatment is advantageous in that the surface of the sample may be damaged only to a smaller degree and thereby the intensity of treatment may be set to a relatively larger degree, although it has been proven only in a relatively limited number of applications, and the cost thereof is higher than that of the corona discharge treatment. Accordingly, more preferable one of the both may be selected, taking trade-off between the damage of the polymer film adopted herein and the level of improvement in the adhesiveness after the treatment, into consideration.

The surface of the film subjected to these treatments is hydrophilized. Contact angle of water on the treated surface may be adoptable as an index of hydrophilization. More specifically, the contact angle of water is preferably 55° or smaller, and more preferably 50° or smaller. If the contact angle of water on the treated surface is adjusted to the above-described ranges, the surface may be improved in the adhesiveness with an optically anisotropic layer or alignment film formed thereon, and may be made less causative of failures such as separation. The lower limit value is not specifically limited, so far as the value is set so as not to damage the polymer film. The contact angle may be measured according to JIS R3257 (1999). Conditions for the corona discharge treatment and atmospheric-pressure plasma treatment may be determined so as to make the contact angle fall in the above-described ranges. Conditions variable in both methods may include applied voltage, frequency, atmospheric gas species, treatment time, and so forth.

Details for these treatments are given in “Kobunshi Hyomen Kaisitsu (Polymer Surface Modification)”, published by Kindai Publishing Company), p.88-; “Kobunshi Hyomen no Kiso to Oyo (Basics and Applications of Polymer Surface)”, Part II, published by Kagaku Dojin Publishing Company, Inc., p.31-; and “Taikiatsu Purazuma no Genri•Tokucho to Kobunshi Firumu•Garasu Kiban no Hyomen Kaishitsu Gijutsu (Principles and Features of Atmospheric-Pressure Plasma, and Surface Modification Techniques of Polymer Films and Glass Substrates)”, published by Technical Information Institute Co., Ltd., and can be referred to.

### <<Dust Removal Treatment>>

The surface of the film, in particular the surface subjected to the corona discharge treatment or atmospheric-pressure plasma treatment (occasionally it is referred to as “treated surface”, hereinafter), may preferably be subjected to a dust removal treatment, before any layer is formed thereon. Methods of dust removal are not specifically limited. A dust removal treatment employing ultrasonic wave is preferable. The ultrasonic dust removal is described in detail in Japanese Laid-Open Patent Publication No. 7-333613, which can be used in the invention.

For the case where the alignment film described later is formed, the dust removal treatment is preferably carried out also to the rubbed surface of the alignment film.

### <<Swelling Treatment>>

A coating liquid may be applied to the surface of the film to form a layer. In such a case, if the film is swelled to a certain degree by the solvent contained in the coating liquid, the adhesiveness between the film and the layer may be improved. More specifically, the adhesiveness may be improved without causing whitening of the coated layer, by using a solvent prepared by mixing a solvent capable of swelling the film and another solvent incapable of swelling the film in a certain ratio.

### (Optically Anisotropic Layer)

The optical film of the present invention has an optically anisotropic layer formed of a liquid crystal composition. The liquid crystal composition is preferably curable. The liquid crystal composition contains at least one species of liquid crystal compound. As the liquid crystal compound, rod-like liquid crystal compound or discotic liquid crystal compound is preferable. Whichever of low-molecular-weight compound and polymer compound may be adoptable as the liquid crystal compound used for preparing the liquid crystal composition. The low-molecular-weight liquid crystal compound may preferably be selected from liquid crystal compounds having polymerizable groups. When the optically anisotropic layer is formed using a liquid crystal compound having polymerizable groups, the liquid crystal compound in the layer will no more exhibit liquid crystallinity, because the compound will be fixed in a predetermined alignment in the optically anisotropic layer, while being polymerized via the polymerizable groups. On the other hand, when the optically anisotropic layer is formed using a liquid crystal composition containing a polymer liquid crystal compound, the alignment state of the polymer liquid crystal compound will be fixed after being aligned in a predetermined state and then by cooling it down to a temperature equal to or lower than the glass transition point of the polymer.

Examples of a rod-like liquid crystal compound include azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans and alkenyl cyclohexyl benzonitriles.

For immobilizing rod-like molecules, polymerization or curing reaction of polymerizable groups introduced in the terminal portion of molecules may be employed. More specifically, JPA No. 2006-209073 discloses examples of immobilizing polymerizable nematic rod-like liquid crystal compounds with UV light. And it is also possible to use, as a rod-like liquid crystalline compound, liquid crystalline polymers comprising a repeating unit having a residue of a rod-like liquid crystalline compound. The optical compensation film produced by using liquid crystal polymer is disclosed in JPA No. hei 5-53016.

Examples of a discotic liquid-crystalline compound include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B.Kohne et al.; and macrocycles based aza-crowns or phenyl acetylenes described in “J. Chem. Commun.”, page 1794 (1985), M. Lehn et al. and “J. Am. Chem. Soc.”, vol. 116, page 2,655 (1994), J. Zhang et al. The polymerization of discotic liquid-crystalline compounds is described in JPA No. hei 8-27284.

In order to immobilize discotic liquid crystalline molecules by polymerization, a polymerizable group has to be bonded as a substituent group to a disk-shaped core of the discotic liquid crystalline molecule. In a preferred compound, the disk-shaped core and the polymerizable group are preferably bonded through a linking group, whereby the aligned state can be maintained in the polymerization reaction. Preferred examples of the discotic liquid crystalline compound having a polymerizable group include the group represented by a formula (A) below.

D(-L-P)ₙ (A)

In the formula, D is a disk-shaped core, L is a divalent liking group, P is a polymerizable group and n is an integer from 4 to 12.

Examples of the disk-shaped core D include, but are not limited to, those shown below. In each of the examples, LP or PL means the combination of the divalent linking group (L) and the polymerizable group (P).

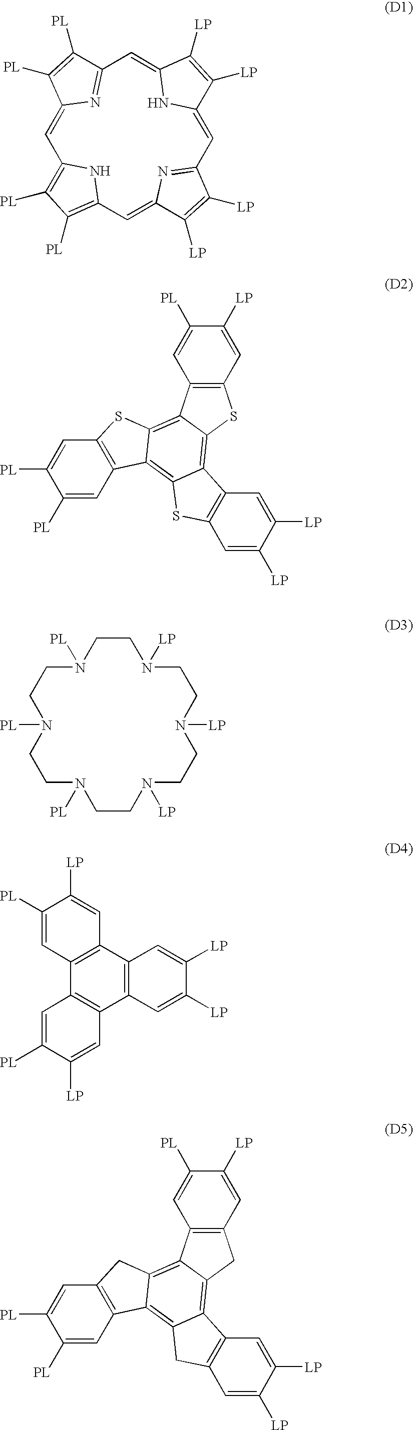

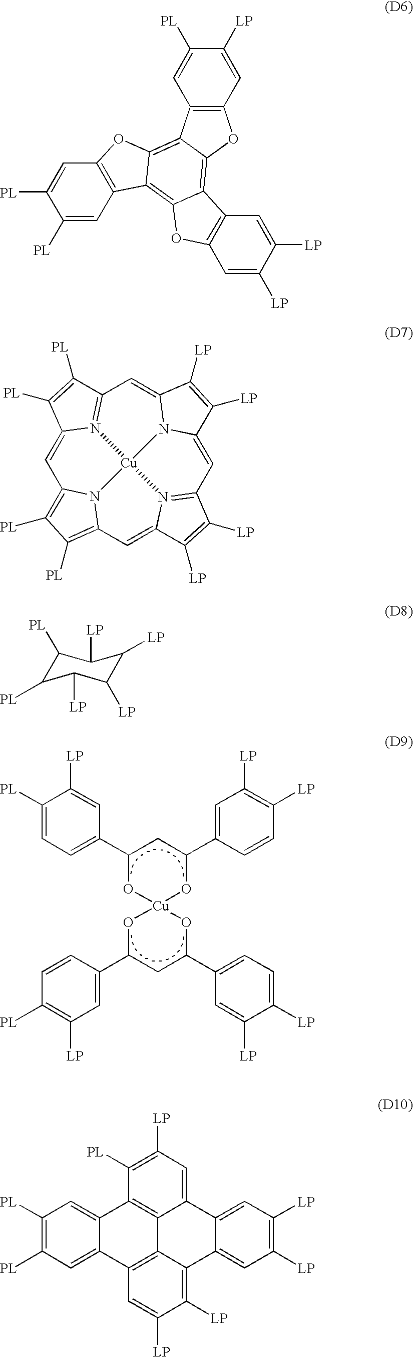

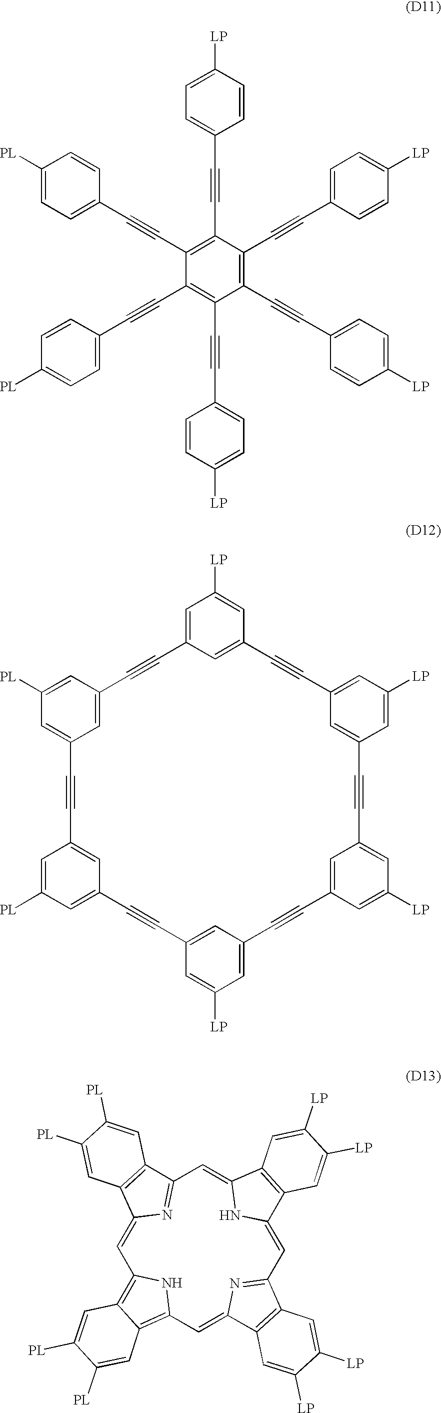

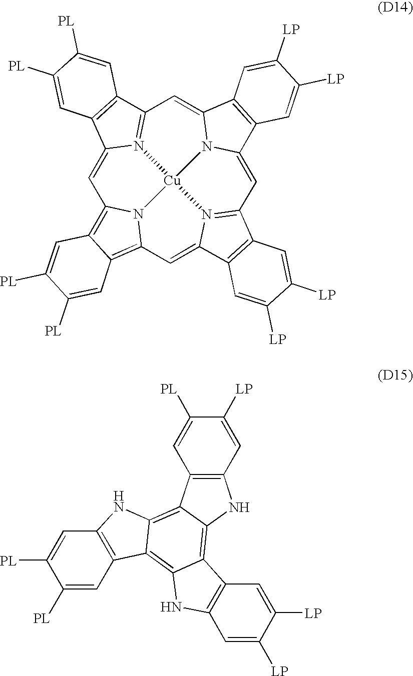

And compounds having a tri-substituted benzene skeleton described in JPA No. 2007-102205 are preferred since their birefringence exhibits a wavelength dependency similar to that of liquid crystal material to be usually used in a liquid crystal cell. Among those, the benzene skeleton shown below is preferred.

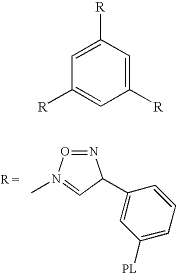

In the formula, preferably, the bivalent linking group L represents a bivalent linking group selected from the group consisting of alkylenes, alkenylenes, arylenes, —CO—, —NH—, —O—, —S— and any combinations thereof. More preferably, the bivalent linking group L represents a bivalent linking group selected from the group consisting of any combinations of two or more selected from alkylenes, arylenes, —CO—, —NH—, —O— and —S—. Even more preferably, the bivalent linking group (L) represents a bivalent linking group selected from the group consisting of any combinations of two or more selected from alkylenes, arylenes, —CO— and —O—. The carbon number of the alkylene may be from 1 to 12, the carbon number of the alkenylene may be from 1 to 12; and the carbon number of the arylene may be from 6to 10.

Examples of the bivalent group (L) include those shown below. In the formulas, the left terminal portion binds to the discotic core (D) and the right terminal side binds to the polymerizable group (P). In the formulas, “AL” represents an alkylene or an alkenylene; and “AR” represents an arylene. The alkylene, alkenylene or arylene may have at least one substituent such as an alkyl group.
L1:-AL-CO—O-AL-
L2:-AL-CO—O-AL-O—
L3:-AL-CO—O-AL-O-AL-
L4:-AL-CO—O-AL-O—CO—
L5:—CO-AR-O-AL-
L6:—CO-AR-O-AL-O—
L7:—CO-AR-O-AL-O—CO—
L8:—CO—NH-AL-
L9:—NH-AL-O—
L10:—NH-AL-O—CO—
L11:—O-AL-
L12:—O-AL-O—
L13:—O-AL-O—CO—
L14:—O-AL-O—CO—NH-AL-
L15:—O-AL-S-AL-
L16:—O—CO-AR-O-AL-CO—
L17:—O—CO-AR-O-AL-O—CO—
L18:—O—CO-AR-O-AL-O-AL-O—CO—
L19:—O—CO-AR-O-AL-O-AL-O-AL-O—CO—
L20:—S-AL-
L21:—S-AL-O—
L22:—S-AL-O—CO—
L23:—S-AL-S-AL-
L24:—S-AR-AL-

In the formula (A), the polymerizable group (P) may be selected depending on the types of polymerization to be employed. Examples of the polymerizable group (P) include those shown below.

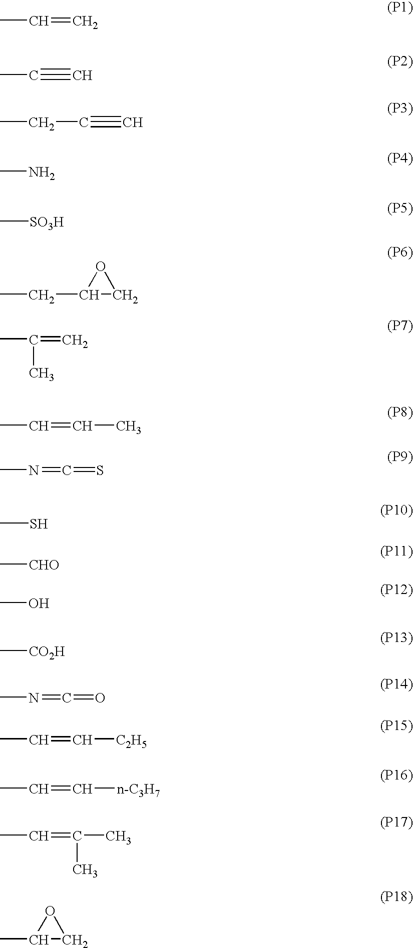

Preferably, the polymerizable group (P) is selected from unsaturated polymerizable groups, P1, P2, P3, P7, P8, P15, P16 and P17, or epoxy groups, P6 and P18. More preferably the polymerizable group is selected from the unsaturated polymerizable groups, and even more preferably it is selected from ethylenic unsaturated polymerizable groups, P1, P7, P8, P15, P16 and P17.

In formula (A), n is an integer from 4 to 12, and n may be decided depending on types of discotic core (D) to be employed. In the formula, the plurality of the combination of L and P may be same or different from each other, and preferably the plurality of the combination is same.

In the liquid crystal composition, the amount of the liquid crystal compound is preferably from 50% by mass to 99.9% by mass with respect to the total mass of the composition (solid content, for the case of containing a solvent), more preferably from 70% by mass to 99.9% by mass, and still more preferably from 80% by mass to 99.5% by mass.

Uniformity of the layer mechanical strength of the layer, alignment performance of the liquid crystal compound and so forth may be improved by using a plasticizer, surfactant, polymerizable monomer and so forth together with the above-described liquid crystal compound in the liquid crystal composition. These materials may preferably have compatibility with the liquid crystal compound, so as not to inhibit the alignment.

Examples of the polymerizable monomer to be used include radical-polymerizable or cation-polymerizable compounds. Polyfunctional radical-polymerizable monomers are preferred, and among those, the compounds which can co-polymerize with the liquid crystal compound having a polymerizable group(s). Examples of such a compound include those described in the paragraphs [0018] to [0020] of JPA No.2002-296423. The amount of the compound is preferably from 1 to 50 mass % and more preferably from 5 to 30 mass % with respect to the amount of the liquid crystal compound.

The polymer to be used along with the liquid crystal compound may be selected from the polymers capable of increasing viscosity of coating liquid. Examples of such polymer include cellulose esters. Preferred examples of cellulose ester include those in the paragraph [0178] of JPA No. 2000-155216. Avoiding inhibition of orientation of liquid crystal molecules, preferably, the amount of the polymer is from 0.1 to 10 mass % and more preferably from 0.1 to 8 mass % with respect to the amount of the liquid crystal compound.

Various types of surfactants may be used in the invention, and fluorosurfactants are preferred. More specifically, the compounds described in the paragraphs [0028] to [0056] of JAP No. 2001330725, compounds described in the paragraphs [0069] to [0126] of JPA No.2005-062673 may be used. Preferred examples of the surfactant to be used include the polymers having a fluroaliphatic group(s) described in the paragraphs [0054] to [0109] of JPA No. 2005-292351.

The optically anisotropic layer may be formed by applying a liquid crystal composition, containing the above-described components, to the surface of the film, that is the transparent support, or to the surface of the alignment film optionally formed on the film (preferably to the rubbed surface), allowing alignment to proceed at a temperature not higher than the transition temperature between the liquid crystal phase and the solid phase, then allowing a polymerization reaction to proceed by UV irradiation, to thereby fix the liquid crystal compound in the alignment state. The liquid crystal composition may be coated by any known methods (for example, bar coating, extrusion coating, direct gravure coating, reverse gravure coating, die coating). The transition temperature between the liquid crystal phase and the solid phase preferably falls in the range from 70° C. to 300° C., and particularly preferably from 70° C. to 170° C.

Photo-polymerization of the liquid crystal compound may be carried out. Irradiation of light for polymerizing the liquid crystal compound may preferably carried out using ultraviolet radiation, where the irradiation energy preferably falls in the range from 20 to 5000 mJ/cm², and more preferably from 100 to 800 mJ/cm². The irradiation of light may be carried out under heating, in order to accelerate the photo-polymerization reaction. The heating may be proceeded approximately at 120° C. or below, but not specifically limited, so as not to degrade the degree of alignment of the liquid crystal compound.

### (Alignment Film)

The alignment film is preferably used for preparing the optically anisotropic layer by coating a composition containing the polymerizable liquid crystal. The material of the alignment film is preferably selected from polyvinyl alcohols or modified polyvinyl alcohols. As the polyvinyl alcohol (PVA), those typically having an average degree of saponification of 70 to 100% may be preferable, those having an average degree of saponification of 80 to 100% may be more preferable, and those having an average degree of saponification of 85 to 98% are still more preferable. From the viewpoint of the average degree of polymerization, PVA having an average degree of polymerization 100 to 3000 is preferable. Examples of the modified polyvinyl alcohol (modified PVA) include those modified by copolymerization (examples of the modified group in the modified PVA, prepared by copolymerization, include COONa, Si(OX)₃, N(CH₃)₃.Cl, C₉H₁₉COO, SO₃Na and C₁₂H₂₅); those modified by chain transfer reaction (examples of the modified group in the modified PVA, prepared by chain transfer reaction, include COONa, SH, alkylthio and C₁₂H₂₅); and those modified by block polymerization (examples of the modified group in the modified PVA, prepared by block polymerization, include COOH, CONH₂, COOR and C₆H₅). In the terms of average degree of polymerization, the modified PVA having an average degree of polymerization of 100 to 3000 is preferable (more preferably 300 to 2400, and still more preferably 1000 to 1700). Among these, unmodified and modified PVA having average degrees of saponification of 80 to 100% are preferable, and unmodified and alkylthio-modified PVA having average degrees of saponification of 85 to 98% are particularly preferable.

Another example of the method for forming the optically anisotropic layer on the transparent support may include a step for transferring an optically anisotropic layer once formed on another polymer film onto the transparent support. This method may be preferable because there is no need of considering heat resistance of the support, even if heating is necessary for forming the layer. An example of the method is as follows. First, a liquid crystalline polymer such as liquid crystalline polyester or the like is dissolved into an organic solvent to prepare a coating liquid. The coating liquid is then coated onto the rubbed surface of a polyethylene terephthalate film. The coated layer is heated to 100° C. or above, and then cooled to align the liquid crystal polymer, and the alignment state is fixed to obtain an optically anisotropic layer. Next, a UV-curing adhesive is applied to the surface of the optically anisotropic layer, the transparent support is disposed on the adhesive layer, and then the adhesive layer is cured by irradiating ultraviolet radiation so as to bond the transparent support and the adhesive layer. As a consequence, polyethylene terephthalate may readily be separated from the optically anisotropic layer, and thereby the optical film of the present invention, having the adhesive layer on the transparent support, and further having thereon the optically anisotropic layer, may be obtained. In this method, use of the UV-curing adhesive as the adhesive is preferable in terms of increasing adhesiveness with the transparent support. Examples of the adhesive include epoxy-base, UV-curing adhesives; polymer adhesives such as those of acryl-base, vinyl alcohol-base, silicone-base, polyester-base, polyurethane-base and polyether-base; isocyanate-base adhesives; and rubber-base adhesives. Examples of the liquid crystalline polymer include polymers capable of forming anisotropic melt phase, which are more specifically p-hydroxybenzoic acid/polyethyleneterephthalate-base liquid crystalline polyesters, p-hydroxybenzoic acid/6-hydroxy-2-naphtoic acid-base liquid crystalline polyesters, and p-hydroxybenzoic acid/4,4′-dihydroxy biphenyl/terephthalic acid/isophthalic acid-base liquid crystalline polyesters, but are not limited thereto.

The thickness of the optically anisotropic layer is preferably from 0.5 to 100 μm or around, and more preferably from 0.5 to 30 μm or around.

### [Polarizing Plate]

The present invention relates also to a polarizing plate having at least the optical film of the present invention and a polarizing film.

The polarizing film and the optical film of the present invention may be bonded using a pressure-sensitive adhesive or an adhesive. The pressure-sensitive adhesive or the adhesive is preferably selected from materials excellent in transparency. Examples of the adhesive include polymer adhesives of acryl-base, vinyl alcohol-base, silicone-base, polyester-base, polyurethane-base and polyether-base; isocyanate-base adhesive; and rubber-base adhesives. Examples of the pressure-sensitive adhesive include those of acryl-base, vinyl alcohol-base, silicone-base, polyester-base, polyurethane-base, polyether-base, isocyanate-base and rubber-base.

Smaller thickness of the adhesive layer placed between the polarizing film and the optical film of the present invention is more preferable. The thickness is preferably not larger than 10 μm or around, and more preferably not larger than 5 μm or around.

According to the invention, a polarizing film obtained by dying a polyvinyl alcohol film with iodine, followed by stretching, may typically be adoptable.

The polarizing film preferably has a protective film bonded also to the other surface thereof. A cellulose acylate film, cyclic polyolefin-base polymer film and so forth may be adoptable as the protective film.

### [Liquid Crystal Display Device]

The optical film and the polarizing plate of the present invention may be adoptable to liquid crystal display devices employing any mode such as TN (Twisted Nematic), IPS (In-Plane Switching), FLC (Ferroelectric Liquid Crystal), OCB (Optically Compensatory Bend), STN (Supper Twisted Nematic), VA (Vertically Aligned) and HAN (Hybrid Aligned Nematic) modes.

The internal temperature of a liquid crystal display device is often elevated due to heat from the back light when the device is used over a long duration of time. Liquid crystal display devices for notebook-type personal computers and mobile phones may be used not only in indoor environments but also in outdoor environments. In addition, in-car liquid crystal display devices may excessively be exposed to high temperatures. Accordingly, these liquid crystal display devices are necessarily small in fluctuation of display characteristics against changes in environmental humidity and temperature. The liquid crystal display device having the optical film of the present invention, and in particular the liquid crystal display device having the optical film of the present invention as the protective film for the polarizing film, are characterized by their small fluctuation in the display characteristics against changes in temperature and humidity, and are therefore useful as liquid crystal display devices for various applications.

### EXAMPLES

The present invention will further specifically be explained referring to Examples. Note that materials, amount of use, ratio, details of processes, procedures of processes and so forth described hereinafter may appropriately be modified, without departing from the spirit of the present invention. The scope of the present invention is, therefore, not limited to the specific examples described below.

### (Preparation of Transparent Support)

### Exemplary Preparation 1: Preparation of Transparent Support (PP-0)

A propylene/ethylene random copolymer containing approximately 5% by mass of ethylene unit (Sumitomo Noblen W151, from Sumitomo Chemical Co., Ltd.) was extruded from a monoaxial melt extruder provided with a T-die at a melt temperature of 230° C., to obtain a raw film. The raw film was then subjected to corona discharge treatment on both of the top and back surfaces thereof, and was used as Transparent Support (PP-0).

### Exemplary Preparation 2: Preparation of Transparent Support (PP-1)

A propylene/ethylene random copolymer containing approximately 5% by mass of ethylene unit (Sumitomo Noblen W151, from Sumitomo Chemical Co., Ltd.) was extruded from a monoaxial melt extruder provided with a T-die at a melt temperature of 230° C., to obtain a raw film. The raw film was then biaxially stretched, sequentially by a stretching ratio of 1.5 times in the machine direction, and by a stretching ratio of 1.5 times in the transverse direction, to thereby obtain a transparent film having Re=2 nm and Rth=95 nm. The transparent film was then subjected to corona discharge treatment on both of the top and back surfaces thereof, and was used as Transparent Support (PP-1).

### Exemplary Preparation 3: Preparation of Transparent Support (PP-2)

The polypropylene raw-film was obtained in the same manner as described in Exemplary Preparation 1, and was then biaxially stretched sequentially by a stretching ratio of 1.2 times in the machine direction, and by a stretching ratio of 2.5 times in the transverse direction, to thereby obtain a transparent film showing Re=82 nm, Rth=59 nm. The transparent film was then subjected to corona discharge treatment on both of the top and back surfaces thereof, and was used as Transparent Support (PP-2).

### Exemplary Preparation 4: Preparation of Transparent Support (PP-3)

The polypropylene raw-film was obtained in the same manner as described in Exemplary Preparation 1, and was then biaxially stretched sequentially by a stretching ratio of 1.8 times in the machine direction, and by a stretching ratio of 2.7 times in the transverse direction, to thereby obtain a transparent film showing Re=40 nm, Rth=180 nm. The transparent film was then subjected to corona discharge treatment on both of the top and back surfaces thereof, and was used as Transparent Support (PP-3).

### Exemplary Preparation 5: Preparation of Transparent Support (PP-4)

The polypropylene raw-film was obtained in the same manner as described in Exemplary Preparation 1, and was then biaxially stretched sequentially by a stretching ratio of 2.8 times in the machine direction, and by a stretching ratio of 3.7 times in the transverse direction, to thereby obtain a transparent film showing Re=47 nm, Rth=300 nm. The transparent film was then subjected to corona discharge treatment on both of the top and back surfaces thereof, and was used as Transparent Support (PP-4).

### Exemplary Preparation 6: Preparation of Transparent Support (PP-5)

The polypropylene raw-film was obtained in the same manner as described in Exemplary Preparation 1, and was then biaxially stretched sequentially by a stretching ratio of 1.6 times in the machine direction, and by a stretching ratio of 2.5 times in the transverse direction, to thereby obtain a transparent film showing Re=50 nm, Rth=130 nm. The transparent film was then subjected to corona discharge treatment on both of the top and back surfaces thereof, and was used as Transparent Support (PP-5).

### Exemplary Preparation 7: Preparation of Transparent Support (PP-6)

The polypropylene raw-film was obtained in the same manner as described in Exemplary Preparation 1, and was then biaxially stretched sequentially by a stretching ratio of 1.1 times in the machine direction, and by a stretching ratio of 2.0 times in the transverse direction, to thereby obtain a transparent film showing Re=50 nm, Rth=40 nm. The transparent film was then subjected to corona discharge treatment on both of the top and back surfaces thereof, and was used as Transparent Support (PP-6).

### Example 1

### (Process of Preparing Alignment Layer)

To one surface of Transparent Support (PP-1) prepared in Exemplary Preparation 2, a curable composition for forming an alignment film having the formulation shown below was applied using a #14 wire bar to as much as 24 mL/m² on the wet basis, dried at 100° C. for 2 minutes, and then heated to 130° C. for 2.5 minutes, to thereby form an alignment film The thickness of the alignment film was found to be 1.0 μm.

### Formulation of Curable Composition for Forming Alignment Film:

| | |
|---|---|
| Modified polyvinyl alcohol shown below | 40 parts by mass |
| Water | 728 parts by mass |
| Methanol | 228 parts by mass |
| Glutaraldehyde (crosslinking agent) | 2 parts by mass |
| Citrate ester (AS3, from Sankyo Chemical | 0.69 parts by mass |
| Industries, Ltd.) | |

Modified Polyvinyl Alcohol

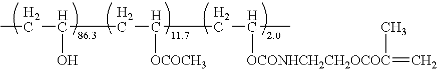

### (Process of Preparing Optically Anisotropic Layer)

A coating liquid of Liquid Crystal Composition 1 for forming an optically anisotropic layer, having the formulation shown below, was prepared.

### Formulation of Liquid Crystal Composition 1

| | |
|---|---|
| Methyl ethyl ketone | 270.0 parts by mass |
| Discotic liquid crystal compound 1 shown below | 10.0 parts by mass |
| Discotic liquid crystal compound 2 shown below | 90.0 parts by mass |
| Air-interface-side alignment controller agent 1 | 1.0 parts by mass |
| shown below | |
| Photo-polymerization initiator | 3.0 parts by mass |
| (“Irgacure 907”, from CIBA-Geigy K.K.) | |
| Sensitizer, “Kayacure DETX”, from Nippon Kayaku | 1.0 parts by mass |
| Co., Ltd. | |

Discotic liquid crystal compound 1

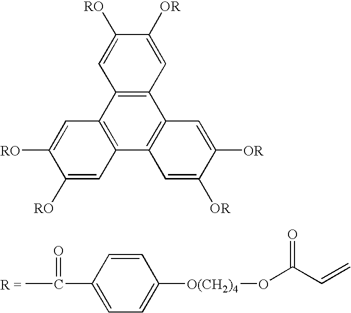

Discotic liquid crystal compound 2

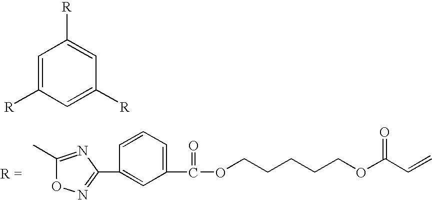

Air-Interface-side alignment controller 1

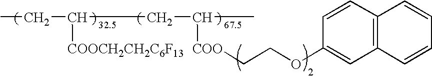

The wind-up film having the alignment film formed thereon was fed out to a rubbing machine disposed on the downstream side, rubbed on the surface of the alignment film while rotating a rubbing roll reversely to the direction of feeding, and the rubbed surface was then subjected to a dust removal treatment employing ultrasonic. After the dust removal treatment, to the rubbed surface, a coating liquid of Liquid Crystal Composition 1 for forming the optically anisotropic layer having the formulation shown in the above was applied using a #1.6 wire bar to as much as 2.8 mL/m² on the wet basis, dried at 115° C. for 1.5 minutes for alignment. The film was then irradiated with UV light at an irradiation energy of 200 mJ/cm² using a 120-W/cm metal halide lamp, while keeping the film temperature at 80° C., so as to proceed polymerization reaction to fix the alignment state, to thereby obtain an optically anisotropic layer (Optically Anisotropic Layer 1). The film was then winded up in the winding section to obtain an optical film (Optical Film 1). The thickness of the optically anisotropic layer was found to be 0.9 μm, showing Re=43 nm and Rth=80 nm.

(Process of Preparing Polarizing plate 1)

A polyvinyl alcohol (PVA) film of 80 μm thick was immersed in an aqueous iodine solution containing 0.05% by mass of iodine at 30° C. for 60 seconds for dying, then immersed in an aqueous boric acid solution containing 4% by mass of boric acid for 60 seconds and stretched while being immersed so that the length in the longitudinal direction was 5 times longer than the original length, and dried at 50° C. for 4 minutes, to thereby obtain a polarizing film of 20 μm thick.

A commercially-available cellulose acetate film was immersed in a 1.5 mol/L aqueous sodium hydroxide solution at 55° C., and washed thoroughly with water so as to remove sodium hydroxide. The film was then immersed in a 0.005 mol/L aqueous dilute sulfuric acid solution at 35° C. for one minute, and immersed into water so as to thoroughly wash off the aqueous dilute sulfuric acid solution. Finally, the sample was thoroughly dried at 120° C.

Optical Film 1 prepared as described in the above and the saponified commercially-available cellulose acetate film were bonded while placing the polarizing film in between, or more specifically, bonded respectively to the top and back surfaces of the polarizing film, to thereby obtain a polarizing plate (Polarizing Plate 1). The optical film was bonded while directing the optically anisotropic layer outward. The commercially-available cellulose acetate film used herein was Fujitac TF80UL (from FUJIFILM Corporation). An adhesive for bonding used herein was a polyvinyl alcohol-base adhesive.

As the polarizing film and the protective films to be bonded to both surfaces of the polarizing film were prepared in a wind-up form, they were continuously bonded while keeping the machine directions of the individual wind-up films in parallel to each other. As a consequence, the machine direction of Optical Film 1 and the absorption axis of the polarizing film were parallel to each other.

### (Preparation of TN-Mode Liquid Crystal Display Device 1)

A pair of polarizing plates (an upper polarizing plate and a lower polarizing plate) were removed from a 22-inch liquid crystal display device (Model AL2216W from Acer Inc.) employing a TN-mode liquid crystal cell, and, instead of them, Polarizing Plate 1 prepared in the above was disposed at the observer's side and at the back light side, so that the optically anisotropic layer faced to the liquid crystal cell side, using a pressure-sensitive adhesive SK-1478 (from Soken Chemical and Engineering Co., Ltd.) in between. In this way, a TN-mode liquid crystal display device (Liquid Crystal Display Device 1) having two Polarizing Plates 1 was prepared. The individual polarizing plates herein were disposed so that the transmission axis of the polarizing plate on the observer's side (upper polarizing plate) and the transmission axis of the polarizing plate on the back light side (lower polarizing plate) were orthogonal to each other.

### (Evaluation of Display Performance)

Liquid Crystal Display Device 1 was allowed to stand in a thermostatic and hygrostatic room (25° C., 60% RH), for one week, and the contrast ratio in the direction along the normal line of the displaying plane (transmissivity in the white state/transmissivity in the black state) and high-contrast viewing angles in the lateral and vertical directions (ranges of viewing angle within which a contrast of 10 or lager may be ensured), and color tone at the upper portion of the panel were measured using a measuring instrument (EZ-Contrast 160D, from ELDIM), and thereby maximum blueness v′ in the upper direction was evaluated.

Liquid Crystal Display Device 1 was also allowed to stand in a thermostatic and hygrostatic room for two hours or longer while keeping the power turned off, then the power is turned on, and luminance was measured within 5 minutes at four points respectively recessed by 1 cm from the individual centers of the upper, lower, left and right edges towards the center, using a luminance meter (BM-5, from TOPCON Technohouse Corporation). An average value of the measured luminance was found to be 0.3 cd/cm². Similar measurement carried out one hour after the power is turned on yielded a value of 0.5 cd/cm². From the results, change in the luminance ascribable to temperature change was found to be 0.2 cd/cm².

Liquid Crystal Display Device 1 was also allowed to stand at 25° C., 10% RH for 72 hours while keeping the power turned off, then the power is turned on, and immediately thereafter color tone was measured at the same point in the upper direction of the panel where the maximum blueness v′ was measured under normal temperature and normal humidity as described above. Comparing with the maximum blueness v′ measured under normal temperature and normal humidity, Δv′=0.01 was found. From the result, it was found that change in the maximum blueness v′ in the upper direction ascribable to change in humidity was 0.01.

### (Evaluation of Durability)

Only the panel was taken out from the TN-mode Liquid Crystal Display Device 1, and annealed at 105° C. in a dry atmosphere for 240 hours. No separation of the polarizing plate from the panel was observed. The results are shown in Table below.

### Example 2

Transparent Support (PP-1)′ was prepared in the same manner as Transparent Support (PP-1), except that both of the top and back surfaces were not subjected to corona discharge treatment.

The alignment film and the optically anisotropic layer were formed thereon in the same manner as Example 1, to thereby prepare an optical film (Optical Film 2). Using Optical Film 2, a polarizing plate (Polarizing Plate 2) and a TN-mode liquid crystal display device (Liquid Crystal Display Device 2) were prepared in the same manner as Example 1, and evaluated in the same manner as Example 1.

### (Evaluation of Durability)

Only the panel was taken out from the TN-mode liquid crystal display device (Liquid Crystal Display Device 2), and annealed at 105° C. in a dry atmosphere for 240 hours. Separation between the transparent support (PP-1) and the optically anisotropic layer (Optically Anisotropic Layer 1) was observed over a 5-mm range from each of the upper, lower, left and right edges. The results are shown in Table below.

### Example 3

Transparent Support (PP-1), prepared in Exemplary Preparation 2 was used, and the alignment film was formed on the surface thereof in the same manner as Example 1.

### (Process of Preparing Optically Anisotropic Layer)

A coating liquid of Liquid Crystal Composition 2 for forming an optically anisotropic layer, having the formulation shown below, was prepared.

### Formulation of Liquid Crystal Composition 2

| | |
|---|---|
| Methyl ethyl ketone | 102.00 parts by mass |
| Discotic liquid crystal compound 1 | 41.01 parts by mass |
| Ethylene oxide-modified trimethylolpropane | 4.06 parts by mass |
| acrylate (V360, from Osaka Organic Chemical | |
| Industry, Ltd.) | |
| Cellulose acetate butyrate | 0.11 parts by mass |
| (CAB531-1, from Eastman Chemical Company) | |
| Cellulose acetate butyrate | 0.33 parts by mass |
| (CAB551-0.2, from Eastman Chemical Company) | |
| Photo-polymerization initiator | 1.35 parts by mass |
| (“Irgacure 907”, from CIBA-Geigy K.K.) | |
| Sensitizer | 0.45 parts by mass |
| (“Kayacure DETX”, from Nippon Kayaku Co., | |
| Ltd.) | |
| Fluoroaliphatic group-containing polymer 1 | 0.23 parts by mass |
| shown below | |
| Fluoroaliphatic group-containing polymer 2 | 0.03 parts by mass |
| shown below | |

Fluoroaliphatic group-containing polymer 1

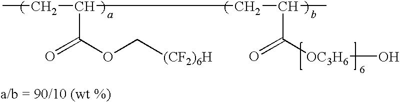

Fluoroaliphatic group-containing polymer 2

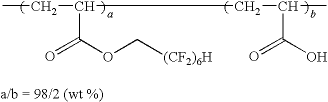

The wind-up film having the alignment film formed thereon was fed out to a rubbing machine disposed on the downstream side, rubbed on the surface of the alignment film while rotating a rubbing roll reversely to the direction of feeding, and the rubbed surface was then subjected to a dust removal treatment employing ultrasonic. After the dust removal treatment, to the rubbed surface, a coating liquid of the liquid crystal composition 2 for forming the optically anisotropic layer having the formulation shown above was applied using a #2.0 wire bar to as much as 3.5 mL/m² on the wet basis, and dried at 125° C. for 2 minutes for alignment. The film was then irradiated with UV light at an irradiation energy of 200 mJ/cm² using a 120-W/cm metal halide lamp, while keeping the film temperature at 80° C., so as to proceed polymerization reaction to fix the alignment state, to thereby obtain an optically anisotropic layer (Optically Anisotropic Layer 2). The film was then winded up in the winding section to obtain an optical film (Optical Film 3). The thickness of the optically anisotropic layer was found to be 1.4 μm, showing Re=45 nm and Rth=780 nm.

Using thus-prepared Optical Film 3, a polarizing plate (Polarizing Plate 3) and a TN-mode liquid crystal display device (Liquid Crystal Display Device 3) were prepared in the same manner as Example 1, and evaluated in the same manner as Example 1. Results are shown in Table below.

### Example 4

An alignment film was prepared in the same manner as Example 1, except that Transparent Support (PP-2) was used in place of Transparent Support (PP-1).

### (Process of Preparing Optically Anisotropic Layer)

A coating liquid of Liquid Crystal Composition 3 for forming an optically anisotropic layer, having the formulation shown below, was prepared.

### Formulation of Liquid Crystal Composition 3

| | |
|---|---|
| Methyl ethyl ketone | 270.0 parts by mass |
| Discotic liquid crystal compound 1 | 10.0 parts by mass |
| Discotic liquid crystal compound 2 | 90.0 parts by mass |
| Air-interface-side alignment controller 1 | 2.5 parts by mass |
| Photo-polymerization initiator | 3.0 parts by mass |
| (“Irgacure 907”, from CIBA-Geigy K.K.) | |
| Sensitizer | 1.0 parts by mass |
| (“Kayacure DETX”, from Nippon Kayaku Co., | |
| Ltd.) | |

The wind-up film having the alignment film formed thereon was fed out to a rubbing machine disposed on the downstream side, rubbed on the surface of the alignment film while rotating a rubbing roll reversely to the direction of feeding, and the rubbed surface was then subjected to a dust removal treatment employing ultrasonic. After the dust removal treatment, to the rubbed surface, a coating liquid of Liquid Crystal Composition 3 for forming the optically anisotropic layer having the formulation shown in the above was applied using a #1.8 wire bar to as much as 3.1 mL/m² on the wet basis, and dried at 115° C. for 1.5 minutes for alignment. The film was then irradiated with UV light at an irradiation energy of 200 mJ/cm² using a 120-W/cm metal halide lamp, while keeping the film temperature at 80° C., so as to proceed polymerization reaction to fix the alignment state, to thereby obtain an optically anisotropic layer (Optically Anisotropic Layer 3). The film was then winded up in the winding section to obtain an optical film (Optical Film 4). The thickness of the optically anisotropic layer (Optically Anisotropic layer 3) was found to be 1.0 μm, showing Re=32 nm and Rth=95 nm.

Using thus-prepared Optical Film 4, a polarizing plate (Polarizing Plate 4) and a TN-mode liquid crystal display device (Liquid Crystal Display Device 4) were prepared in the same manner as Example 1, and evaluated in the same manner as Example 1. Results are shown in Table below.

### Example 5

### (Process of Preparing Liquid Crystalline Polyester)

A polymerization reaction was proceeded using a mixture of 10 mmol of 4-n-heptylbenzoic acid, 95 mmol of terephthalic acid, 50 mmol of methylhydroquinone diacetate, 50 mmol of catechol diacetate and 100 mg of sodium acetate, under a nitrogen atmosphere at 270° C. for 12 hours. The obtained reaction product was then dissolved into tetrachloroethane, and purified by re-precipitation from methanol, to thereby obtain liquid crystalline polyester represented by the formula below.

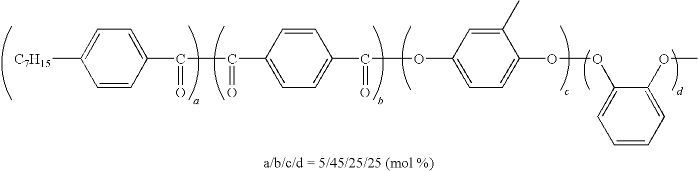

### (Process of Preparing Optically Anisotropic Layer 4)

An 8%-by-mass solution of the above-described liquid crystalline polyester in tetrachloroethane was prepared, and applied to the rubbed polyethylene terephthalate film using a #10 wire bar to as much as 17.3 mL/m² on the wet basis, annealed at 250° C. for 30 minutes, and then cooled for fixation, to thereby obtain an optically anisotropic layer (Optically Anisotropic Layer 4). The thickness of the optically anisotropic layer was found to be 1.4 μm, showing Re=45 nm and Rth=80 nm.

### (Process of Preparing Optical Film 5)

To the surface of Optically Anisotropic Layer 4, formed on a polyethylene terephthalate film, a commercially-available, epoxy-base UV curable resin was applied as thick as 2 μm using a bar coater, further thereon the transparent support (PP-1) manufactured in Exemplary Preparation 2 was stacked, and the adhesive was cured by irradiating ultraviolet radiation. Next, the polyethylene terephthalate film was separated at the interface between the polyethylene terephthalate film and the film composed of the liquid crystalline polyester, and removed, to thereby obtain an optical film (Optical Film 5).

Using thus-prepared Optical Film 5 (Optical Film 5), a polarizing plate (Polarizing Plate 5) and a TN-mode liquid crystal display device (Liquid Crystal Display Device 5) were prepared in the same manner as Example 1, and evaluated in the same manner as Example 1. Results are shown in Table below.

### Example 6

An alignment film was prepared in the same manner as Example 1, except that Transparent Support (PP-3) was used in place of Transparent Support (PP-1).

### (Process of Preparing Optically Anisotropic Layer)

A coating liquid of Liquid Crystal Composition 5 for forming an optically anisotropic layer, having the formulation shown below, was prepared.

### Formulation of Liquid Crystal Composition 5

| | |
|---|---|
| Methyl ethyl ketone | 102.00 parts by mass |
| Discotic liquid crystal compound 1 | 41.01 parts by mass |
| Ethylene oxide-modified trimethylolpropane | 4.06 parts by mass |
| acrylate (V360, from Osaka Organic | |
| Chemical Industry, Ltd.) | |
| Cellulose acetate butyrate | 0.35 parts by mass |
| (CAB531-1, from Eastman Chemical | |
| Company) | |
| Photo-polymerization initiator | 1.35 parts by mass |
| (“Irgacure 907”, from CIBA-Geigy K.K.) | |
| Sensitizer | 0.45 arts by mass |
| (“Kayacure DETX”, from Nippon Kayaku | |
| Co., Ltd.,) | |
| Fluoroaliphatic group-containing copolymer | 0.10 parts by mass |
| (Megafac F780, from DIC Corporation) | |

The wind-up film having the alignment film formed thereon was fed out to a rubbing machine disposed on the downstream side, rubbed on the surface of the alignment film while reversely rotating a rubbing roll in the direction clock-wisely inclined 45° away from the direction of feeding assumed as 0°, and the rubbed surface was then subjected to a dust removal treatment employing ultrasonic. After the dust removal treatment, to the rubbed surface, a coating liquid of the liquid crystal composition 5 for forming the optically anisotropic layer having the composition shown above was applied using a #2.0 wire bar to as much as 3.5 mL/m² on the wet basis, and dried at 125° C. for 2 minutes for alignment. The film was then irradiated with UV light at an irradiation energy of 200 mJ/cm² using a 120-W/cm metal halide lamp, while keeping the film temperature at 80° C., so as to proceed polymerization reaction to fix the alignment state, to thereby obtain an optically anisotropic layer (Optically Anisotropic Layer 5). The film was then winded up in the winding section to obtain an optical film (Optical Film 6). The thickness of the optically anisotropic layer was found to be 1.4 μm, showing Re=32 nm and Rth=90 nm.

Using thus-prepared Optical Film 6, a polarizing plate (Polarizing Plate 6) was prepared in the same manner as Example 1.

### (Process of Preparing OCB-Mode Liquid Crystal Display Device 6)

Glass substrates having ITO electrodes formed thereon were respectively provided with polyimide films as the alignment films, and the alignment films were rubbed. Two thus-obtained glass substrates were opposed so as to align the individual directions of rubbing in parallel to each other, while keeping a 4.1-μm gap, which determines the thickness of the liquid crystal cell, in between. A liquid crystal compound (ZL11132, from Merck KGaA) having a An value of 0.1396 was injected into the gap, to thereby prepare an OCB-mode liquid crystal cell employing bent alignment.

A liquid crystal display device was prepared by combining the bend-aligned liquid crystal cell described in the above, and a pair of Polarizing Plates 6. The bend-aligned liquid crystal cell and the pair of polarizing plates were disposed so that the optically anisotropic layer (Optically Anisotropic Layer 5) of the polarizing plates faced to the substrate of the liquid crystal cell, and so that the direction of rubbing of the bend-aligned liquid crystal cell and the direction of rubbing of the optically anisotropic layer were parallel to each other. Polarizing Plate 6 was bonded respectively on both transparent substrates on the observer's side and on the back light side, so as to hold the bend-aligned liquid crystal cell in between. In this way, a liquid crystal display device (Liquid Crystal Display Device 6) having a 20-inch, bend-aligned liquid crystal cell was prepared.

Thus-prepared, OCB-mode liquid crystal display device, Liquid Crystal Display Device 6, was evaluated in the same manner as Example 1. Results are shown in Table below.

### Example 7

Transparent Support (PP-4) was used in place of Transparent Support (PP-1), and the alignment film was formed on the surface thereof in the same manner as Example 1.

An optically anisotropic layer (Optically Anisotropic Layer 5) was formed on the alignment film in the same manner as Example 6, to thereby prepare an optical film (Optical Film 7). A polarizing plate, Polarizing Plate 7, was further prepared using Optical Film 7 in the same manner as Example 1.

An OCB liquid crystal cell was prepared in the same manner as Example 6, except that the thickness of the liquid crystal cell was adjusted to 7.2 μm, and thereby a 20-inch, OCB-mode liquid crystal display device, Liquid Crystal Display Device 7) was prepared.

The OCB-mode liquid crystal display device was evaluated in the same manner as Example 1. Results are shown in Table below.

### Example 8

### (Process of Preparing Alignment Film)

A curable composition of forming an alignment film, having the formulation shown below, was applied to one surface of Transparent Support (PP-5), using a #1.4 wire bar to as much as 2.4 mL/m² on the wet basis, and dried at 120° C. for 2 minutes, to thereby form an alignment film. The thickness of the alignment film was found to be 1.2 μm.

### Formulation of Curable Composition for Forming Alignment Film:

| | |
|---|---|
| Methyl ethyl ketone | 50 parts by mass |
| Vertical alignment film (JALS-204R, | 50 parts by mass |
| from JSR Corporation) | |

### (Process of Preparing Optically Anisotropic Layer)

A coating liquid of Liquid Crystal Composition 6 for forming an optically anisotropic layer, having the formulation shown below, was prepared.

### Formulation of Liquid Crystal Composition 6

| | |
|---|---|
| Methyl ethyl ketone | 92.0 parts by mass |
| Rod-like liquid crystal compound 1 shown below | 38.0 parts by mass |
| Photo-polymerization initiator | 0.6 parts by mass |
| (“Irgacure 907”, from CIBA-Geigy K.K.) | |
| Sensitizer | 0.2 parts by mass |
| (“Kayacure DETX”, from Nippon Kayaku Co., | |
| Ltd.,) | |
| Air-interface-side vertical aligner shown below | 0.02 parts by mass |

Rod-like liquid crystal compound 1

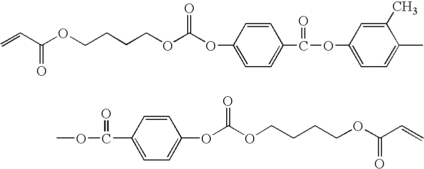

Air-interface-side vertical aligner

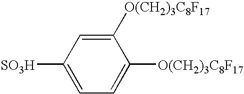

The coating liquid was applied to the surface of the alignment film formed on the transparent film, using a #3.6 wire bar. The coated film was then dried at 100° C. for 2 minutes, and then irradiated with UV light at an irradiation energy of 200 mJ/cm² using a 120-W/cm metal halide lamp, while keeping the film temperature at 80° C., so as to proceed polymerization reaction to fix the alignment state, to thereby obtain an optically anisotropic layer (Optically Anisotropic Layer 6). The film was then winded up in the winding section to obtain an optical film (Optical Film 8). The thickness of the optically anisotropic layer was found to be 1.8 μm, showing Re=0 nm and Rth=−180 nm.

Using thus-prepared Optical Film 8, a polarizing plate (Polarizing Plate 8) was prepared in the same manner as Example 1.

(Process of Preparing Polarizing plate 9)

Polarizing Plate 9 was prepared in the same manner as Example 1, using Transparent Support (PP-0), but without forming thereon any alignment film and optically anisotropic layer.

### (Process of Preparing IPS-Mode Liquid Crystal Display Device 8)

Electrodes were formed on one glass substrate while keeping a distance between the adjacent electrodes of 20 μm, a polyimide film was provided thereon as an alignment film, and rubbed. Another polyimide film was provided on one surface of a separately-obtained glass substrate, and rubbed to produce the alignment film. Two glass substrates were stacked so that the alignment films faced to each other, while keeping a gap “d” of 3.9 μm in between, and also aligning the direction of rubbing of two glass substrates in parallel to each other. A nematic liquid crystal composition having a refractive index anisotropy (Δn) of 0.0769 and a dielectric constant anisotropy (Δε) of +4.5 was encapsulated. The liquid crystal layer was found to have a d·Δn value of 300 nm.

On the observer's side (top surface side) of the IPS-mode liquid crystal cell prepared in the above, Polarizing Plate 8 was bonded so that the slow axis of Transparent Support (PP-5) was parallel to the direction of rubbing of the liquid crystal cell (that is, so that the slow axis of PP-5 was parallel to the slow axis of the liquid crystal molecules in the liquid crystal cell in the black state), and so that Optically Anisotropic Layer 6 faced to the liquid crystal cell side. Next, Polarizing Plate 9 was bonded to the other surface of the IPS-mode liquid crystal cell on the back light side (lower surface side), so that Transparent Support (PP-0) of Polarizing Plate 9 faced to the liquid crystal cell side, and so that the crossed-Nicol arrangement of Polarizing Plate 8 and Polarizing Plate 9 was kept. In this way, an IPS-mode liquid crystal display device (Liquid Crystal Display Device 8) was produced.

Thus-prepared, IPS-mode liquid crystal display device, Liquid Crystal Display Device 8, was evaluated in the same manner as Example 1. Results are shown in Table below.

### Example 9

Transparent Support (PP-6) was used in place of Transparent Support (PP-1), and the alignment film was formed on the surface thereof in the same manner as Example 1.

### (Process of Preparing Optically Anisotropic Layer)

A coating liquid of Liquid Crystal Composition 7 for forming an optically anisotropic layer, having the formulation shown below, was prepared.

### Formulation of Liquid Crystal Composition 7

| | |
|---|---|
| Methyl ethyl ketone | 62.0 parts by mass |
| Discotic liquid crystal compound 1 | 32.6 parts by mass |
| Additive shown below | 0.1 parts by mass |
| (additive for aligning disc plane within 5°) | |
| Ethylene oxide-modified trimethylolpropane acrylate | 3.2 parts by mass |
| (V360, from Osaka Organic Chemical Industry, | |
| Ltd.) | |
| Photo-polymerization initiator | 1.1 parts by mass |
| (“Irgacure 907”, from CIBA-Geigy K.K.) | |
| Sensitizer | 0.4 parts by mass |
| (“Kayacure DETX”, from Nippon Kayaku Co., | |
| Ltd.) | |

(Additive)

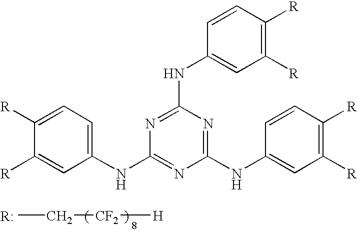

The wind-up film having the alignment film formed thereon was fed out, and a coating liquid of Liquid Crystal Composition 7 for forming an optically anisotropic layer having the formulation shown in the above was applied to the surface using a #2.0 wire bar to as much as 3.5 mL/m² on the wet basis, and dried at 125° C. for 2 minutes for alignment. The film was then irradiated with UV light at an irradiation energy of 200 mJ/cm² using a 120-W/cm metal halide lamp, while keeping the film temperature at 80° C., so as to proceed polymerization reaction to fix the alignment state, to thereby obtain an optically anisotropic layer (Optically Anisotropic Layer 7). The film was then winded up in the winding section to obtain an optical film (Optical Film 9). The thickness of the optically anisotropic layer (Optically Anisotropic Layer 7) was found to be 1.4 μm, showing Re=0 nm and Rth=110 nm.

Polarizing Plate 10 was prepare in the same manner as Example 1, using thus-produced Optical Film 9.

### (Process of Preparing VA-Mode Liquid Crystal Display Device 9)

A liquid crystal cell was prepared by setting a cell gap between the substrates to 3.6 μm, and by dropping and encapsulating a liquid crystal material having a negative dielectric constant anisotropy (“ML C6608”, from Merck KGaA) into the gap, to thereby form a liquid crystal layer between the substrates. The value of retardation (product Δn·d of the thickness d (μm) of liquid crystal layer and the refractive index anisotropy Δn) was adjusted to 300 nm. The liquid crystal material herein was aligned in a vertical manner.

As upper and lower polarizing plates of the liquid crystal display device using the above-described, VA-mode liquid crystal cell, Polarizing Plate 10 was bonded on the observer's side and on the back light side, so that the optically anisotropic layer (Optically Anisotropic Layer 7) faced to the liquid crystal cell side while respectively placing an pressure-sensitive adhesive in between. The transmission axis of the polarizing plate on the observer's side was along the vertical of the plate, and the transmission axis of the polarizing plate on the back light side was along the transverse direction of the plate, so as to give the crossed-Nicol arrangement. In this way, a VA-mode liquid crystal display device (Liquid Crystal Display Device 9) was prepared.

Thus-prepared, VA-mode liquid crystal display device (Liquid Crystal Display Device 9) was evaluated in the same manner as Example 1. Results are shown in Table 2 below.

### Examples 10 to 16

Polarizing plates were prepared in the same manner as Example 1, except that materials shown in Table 3 were used as the modified polyvinyl alcohol, when the alignment film is formed on the support (PP-1).

### (Evaluation of Durability (Evaluation by Forced Thermal Test))

Using thus-prepared polarizing plates, a TN-mode liquid crystal display device was prepared in the same manner as Example 1. Next, only the panel was taken out from the TN-mode liquid crystal display device, heated at 120° C. in a dry atmosphere for 960 hours. Length of region where the polarizing plate was separated from the edges of the panel was measured. Results are shown in Table 3.

### Comparative Example 1

### (Process of Preparing Cellulose Acetate Film: TAC-1)

A composition having the formulation shown below was placed into a mixing tank, stirred under heating so as to dissolve the individual components, to thereby prepare a cellulose acetate solution.

### Formulation of Cellulose Acetate Solution

| | |
|---|---|
| Cellulose acetate | 100 parts by mass |
| having degree of acetylation of 60.7 to 61.1% | |
| Triphenyl phosphate (placticizer) | 7.8 parts by mass |
| Biphenyl diphenyl phosphate (placticizer) | 3.9 parts by mass |
| Methylene chloride (first solvent) | 336 parts by mass |
| Methanol (second solvent) | 29 parts by mass |
| 1-Butanol (third solvent) | 11 parts by mass |

In another mixing tank, 16 parts by mass of retardation enhancer 1 shown below, 92 parts by mass of methylene chloride and 8 parts by mass of methanol were placed, the mixture was stirred under heating, to thereby prepare a retardation enhancer solution. Thirty-one parts by mass of the retardation enhancer solution was added to 487.7 parts by mass of the cellulose acetate solution, and the mixture was thoroughly stirred to prepare a dope.

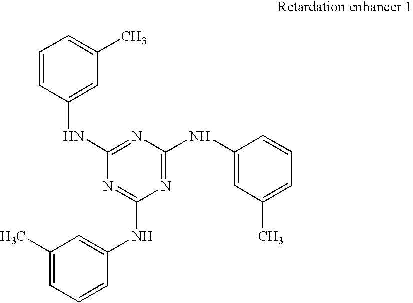

The obtained dope was cast on the band using a band stretching machine. After the film was cooled down to 40° C. on the band, the film was dried at 70° C. for one minute, separated from the band, and dried under dry air at 140° C. for 10 minutes, to thereby prepare a cellulose acetate film (TAC-1) (thickness: 80 μm) having a residual solvent content of 0.3% by mass. Thus-prepared cellulose acetate film (TAC-1) was found to show optical characteristics of Re=7 nm and Rth=93 nm.

Using thus-prepared cellulose acetate film (TAC-1) in place of Transparent Support (PP-1), an alignment film was formed on the surface thereof in the same manner as Example 1, and Optically Anisotropic Layer 1 was formed further thereon, to thereby prepare an optical film (Optical Film 10). Using Optical Film 10, a polarizing plate (Polarizing Plate 11) was prepared in the same manner as Example 1, further a TN-mode liquid crystal display device (Liquid Crystal Display Device 10) was prepared and evaluated in the same manner as Example 1.

### (Evaluation of Durability)

Only the panel was taken out from the TN-mode liquid crystal display device (Liquid Crystal Display Device 10), and heated at 105° C. in a dry atmosphere for 240 hours. Separation between the cellulose acetate film (TAC-1) and the optically anisotropic layer (Optically Anisotropic Layer 1) was observed over a 70-mm region originated from the upper, lower, left and right edges. Results are shown in Table below.

### Comparative Example 2

### (Process of Saponifying Cellulose Acetate Film)

The cellulose acetate film (TAC-1)prepared in Comparative Example 1 was saponified by immersing the film into a 2.0-N potassium hydroxide solution (25° C.) for 2 minutes, followed by neutralization with sulfuric acid, washing with pure water, and drying.

Next, using the cellulose acetate film (TAC-1) in place of Transparent Support (PP-1), an alignment film was formed on the surface thereof in the same manner as Example 1, and an optically anisotropic layer (Optically Anisotropic Layer 1) was formed further thereon, to thereby obtain an optical film (Optical Film 11).

Using the optical film, a polarizing plate (Polarizing Plate 12) and a TN-mode liquid crystal display device (Liquid Crystal Display Device 11) were prepared and evaluated in the same manner as Example 1. Results are shown in Table below

### Comparative Example 3

### (Process of Preparing Cellulose Acetate Film: TAC-2)

The composition having the formulation shown below was placed into a mixing tank, stirred under heating so as to dissolve the individual components, to thereby prepare a cellulose acetate solution.

### Formulation of Cellulose Acetate Solution

| | |
|---|---|
| Cellulose acetate | 100 parts by mass |
| having a degree of acetylation of 60.9% | |
| Triphenyl phosphate | 7.8 parts by mass |
| Biphenyl diphenyl phosphate | 3.9 parts by mass |
| Methylene chloride | 300 parts by mass |
| Methanol | 45 parts by mass |

### (Process of Preparing Retardation Enhancer Solution)

In another mixing tank, 4 parts by mass of cellulose acetate (linter) having a degree of acetylation of 60.9%, 25 parts by mass of retardation enhancer 2 shown below, 0.5 parts by mass of silica particle (mean particle size: 20 nm), 80 parts by mass of methylene chloride, and 20 parts by mass of methanol were placed, the mixture was stirred under heating, to thereby prepare a retardation enhancer solution.

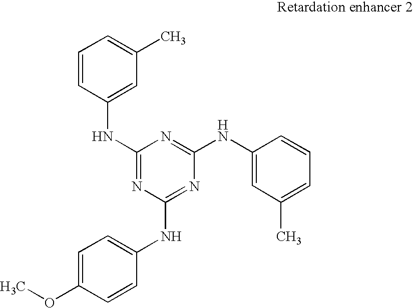

To 470 parts by mass of cellulose acetate solution, 18.5 parts by mass of retardation enhancer was added, and the mixture was thoroughly stirred to obtain a dope. The ratio by mass of the retardation enhancer to the cellulose acetate was 3.5% by mass.

The film having a residual solvent content of 35% by mass was separated from the band, transversely stretched at 140° C. using a tenter by a stretching ratio of 38%, released from the clips and dried at 130° C. for 45 seconds, to thereby manufacture a cellulose acetate film (TAC-2). Thus-prepared cellulose acetate film (TAC-2) was found to have a thickness of 88 μm, showing Re=40 nm and Rth=180 nm.

The cellulose acetate film (TAC-2) was saponified in the same manner as Comparative Example 2. An alignment film was then formed on the surface thereof in the same manner as Example 1, an optically anisotropic layer (Optically Anisotropic Layer 5) was formed further thereon in the same manner as Example 6, to thereby obtain an optical film (Optical Film 12).

Using Optical Film 12, a polarizing plate (Polarizing Plate 13) was prepared, and an OCB-mode liquid crystal display device (Liquid Crystal Display Device 12) was prepared, and performances of which were evaluated in the same manner as Example 1. Results are shown in Table below.

TABLE 1

| | | | Adhesive | | | | | Liquid |
|---|---|---|---|---|---|---|---|---|
| | | Adhesion- | layer for | Optically | | | | Crystal |
| | Support | enhancing | alignment | Anisotropic | Optical | Polarizing | | Display |
| | No. | treatment | film | Layer | Film | Plate | Mode | Device |
| Example 1 | PP-1 | corona | PVA | 1 | 1 | 1 | TN | 1 |
| Example 2 | PP-1′ | none | PVA | 1 | 2 | 2 | TN | 2 |
| Example 3 | PP-1 | corona | PVA | 2 | 3 | 3 | TN | 3 |
| Example 4 | PP-2 | corona | PVA | 3 | 4 | 4 | TN | 4 |
| Example 5 | PP-1 | corona | adhesive | 4 | 5 | 5 | TN | 5 |
| Example 6 | PP-3 | corona | PVA | 5 | 6 | 6 | OCB | 6 |
| Example 7 | PP-4 | corona | PVA | 5 | 7 | 7 | OCB | 7 |
| Example 8 | PP-0, 5 | corona | PVA | 6 | 8 | 8, 9 | IPS | 8 |
| Example 9 | PP-6 | corona | PVA | 7 | 9 | 10 | VA | 9 |
| Comparative | TAC-1 | none | PVA | 1 | 10 | 11 | TN | 10 |
| Example 1 | | | | | | | | |
| Comparative | TAC-1 | saponification | PVA | 1 | 11 | 12 | TN | 11 |
| Example 2 | | | | | | | | |
| Comparative | TAC-2 | saponification | PVA | 5 | 12 | 13 | OCB | 12 |
| Example 3 | | | | | | | | |

TABLE 2

| | | | | | Temperature- | | |
|---|---|---|---|---|---|---|---|
| | | | Upper/lower | Blueness in | dependence of | Moisture- | |
| | | Frontal | CR20 viewing | upper direction | non- | dependence of | Separation in |
| | Mode | CR | angle | v′ | uniformity* | color tone | thermal test |
| Example 1 | TN | 1050 | 168 | 0.4 | 0.2 | 0.01 | none |
| Example 2 | TN | 1050 | 168 | 0.4 | 0.2 | 0.01 | 5 mm wide |
| | | | | | | | along edges |
| Example 3 | TN | 950 | 160 | 0.36 | 0.3 | 0.01 | none |
| Example 4 | TN | 1200 | 176 | 0.4 | 0.2 | 0.01 | none |
| Example 5 | TN | 1000 | 155 | 0.4 | 0.3 | 0.01 | none |
| Example 6 | OCB | 1000 | 165 | 0.39 | 0.4 | 0.01 | none |
| Example 7 | OCB | 1000 | 165 | 0.38 | 0.4 | 0.01 | none |
| Example 8 | IPS | 900 | 170 | 0.41 | 0.2 | 0.01 | none |
| Example 9 | VA | 1300 | 175 | 0.43 | 0.4 | 0.01 | none |
| Comparative | TN | 900 | 140 | 0.33 | 2.7 | 0.04 | 70 mm wide |
| Example 1 | | | | | | | along edges |
| Comparative | TN | 900 | 140 | 0.33 | 2.7 | 0.04 | none |
| Example 2 | | | | | | | |
| Comparative | OCB | 800 | 150 | 0.35 | 2.2 | 0.06 | none |
| Example 3 | | | | | | | |

*“Temperature-dependence of non-uniformity” means difference in luminance (cd/cm²) in the black state measured before and after the display device was illuminated for one hour (luminance in the black state after 1-hour illumination − luminance in the black state before 1-hour illumination).

TABLE 3

| | Polyvinyl alcohol | | | | |
|---|---|---|---|---|---|
| | Degree of | | | | |
| | poly- | | | | Separation in Evaluation |
| | merization | a | b | c | of Durability |
| Example 1 | 300 | 86.3 | 11.7 | 2.0 | 30 mm wide along edges |
| Example 10 | 1700 | 86.3 | 11.7 | 2.0 | 20 mm wide along edges |
| Example 11 | 300 | 96.5 | 1.5 | 2.0 | 20 mm wide along edges |
| Example 12 | 1700 | 96.5 | 1.5 | 2.0 | 10 mm wide along edges |
| Example 13 | 300 | 85.3 | 10.7 | 4.0 | 12 mm wide along edges |
| Example 14 | 1700 | 85.3 | 10.7 | 4.0 | 5 mm wide along edges |
| Example 15 | 300 | 95.5 | 0.5 | 4.0 | 7 mm wide along edges |
| Example 16 | 1700 | 95.5 | 0.5 | 4.0 | none |

In the table, a, b and c represent ratios of polymerization of monomer units in the modified PVA shown below.

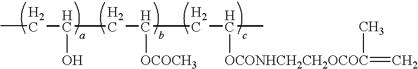

From the results shown in the above, it may be understood that the TN-mode liquid crystal display devices having the optical films of Examples of the present invention not only showed optical compensation performances equivalent to, or superior to those of the similarly-configured conventional optical compensation films, but also proved only small fluctuations in the optical compensation performances against changes in temperature and humidity, and that the TN-, OCB-, IPS- and VA-mode liquid crystal display devices show desirable display characteristics in any environments.

In particular, Examples 1, 3 to 9, in which the surface of the transparent supports are subjected to corona discharge treatment, were found to cause no separation even after the annealing under severe conditions, proving excellent adhesiveness between every adjacent components and excellent heat resistance.

It may be understood from the results shown in Table 3 also that, if compared among the alignment films having the same degrees of saponification, those composed of the modified PVA having a degree of polymerization of 1700 were more effectively improved in the heat resistance, as compared with those composed of the modified PVA having a degree of polymerization of 300.

What is claimed is:

1. An optical film comprising:
a transparent support, and, disposed thereon,
an optically anisotropic layer formed of a composition comprising a liquid crystal compound,
wherein the transparent support is a film comprising polypropylene-base resin(s).

2. The optical film of claim 1, wherein the transparent support is subjected to an adhesion-facilitating treatment.

3. The optical film of claim 1, further comprising an adhesive layer and/or an alignment film, between the transparent support and the optically anisotropic layer.

4. The optical film of claim 1, wherein the optically anisotropic layer is a layer formed of a liquid crystal composition comprising at least a single species of discotic liquid crystal compound.

5. A polarizing plate comprising at least an optical film of claim 1, and a polarizing film.

6. A liquid crystal display device comprising at least a liquid crystal cell, and a polarizing plate of claim 5.

7. A liquid crystal display device of claim 6, wherein the liquid crystal cell employs a TN mode, OCB mode or IPS mode.
